(19) United States
(12) Patent Application Publication
(10) Pub. No.: US 2002/0173214 A1
(43) Pub. Date: Nov. 21, 2002

(54) Cleaning articles and method of making

(75) Inventors: Lawrence J. Mann, Lake Elmo, MN (US); Phillip M. Winter, Birchwood, MN (US)

Correspondence Address: Attention: Gregory D. Allen, Office of Intellectual Property Counsel, 3M Innovative Properties Company, P.O.Box 33427, St. Paul, MN, 55133-3427, US

(73) Assignee: 3M Innovative Properties Company

(21) Appl. No.: 09/833,942

(22) Filed: Apr. 12, 2001

(51) Int. Cl. B32B 5/22; B08B 1/00; D04H 1/00; D04H 5/00; D04H 13/00; D04H 3/00; B08B 7/00

(52) U.S. Cl. 442/417; 134/6; 442/327; 428/317.9; 442/394; 442/402; 442/408; 442/414

(57) ABSTRACT

Cleaning articles comprising a nonwoven web or foam, binder, and organic particles. In another aspect, the present invention provides a method for cleaning soiled surfaces utilizing cleaning articles comprising a nonwoven web or foam, binder, and optionally organic particles

### FIELD OF INVENTION

The present invention relates to articles and methods for cleaning soiled surfaces. More particularly, the present invention relates to cleaning articles comprising nonwoven webs or foam pads, binders, and organic particles, and methods for cleaning soiled surfaces.

### BACKGROUND

A variety of cleaning articles (e.g., bristle brushes, nonwoven webs, foams (including sponges) and cloths have been used to clean numerous types of surfaces. Typically, it is desirable, or even necessary, to clean a surface without damaging it (e.g., scratch the surface or affect the gloss of the surface).

For example, the exterior surfaces of aircraft are typically coated with paint. Commercial aircraft tend to utilize high gloss paints, while military aircraft tend to utilize low gloss paints. These surfaces need to be cleaned periodically to remove surface and embedded soil (e.g., dirt, grim, grease, etc). In cleaning these surfaces, it is desirable, and in some cases necessary, not to scratch the paint or significantly affect the level of gloss. Cleaning articles used to clean such soiled surfaces include bristle brushes, nonwoven webs, foams, and cloths. Frequently, the cleaning articles are used together with a cleaning material such as a detergent cleaning solution or a polish.

Examples of nonwoven cleaning articles marketed to the aircraft industry for use in cleaning soiled aircraft surfaces include those available commercially from the 3M Company, St. Paul, Minn., under the trade designations “SUPER POLISH INDUSTRIAL SHEET” and “TYPE T SURFACE CONDITIONING SHEET”. The former is a polyester fiber web that includes a talc filled styene-butadiene rubber resin having a T_{g} of +4. The latter is a needle punched polyester fiber web that includes a talc filled polyurethane binder.

While conventional techniques utilizing such articles and cleaner materials have been useful, there is a need to more consistently and/or more easily clean soiled surfaces without significantly scratching or affecting the gloss level of the surface.

### SUMMARY OF THE INVENTION

The present invention provides cleaning articles. In one aspect, the present invention provides a cleaning article comprising a non-woven, three-dimensional fibrous web, a binder having a T_{g} not greater than +10° C., and a plurality of organic particles having a Shore A hardness less than 80 (typically in the range from 10 to less than 80 or even 20 to less than 80). The web is comprised of at least one (typically a plurality of) intertangled organic fiber(s). The binder is on at least a portion of a first major surface of the web, and binds the organic particles, at least in part, to the first major surface. Preferably, the binder is present on at least a majority of the first major surface. Typically, the binder is substantially co-extensive with the first major surface. Typically, the binder has a T_{g} in the range from +10° C. to −70° C., preferably from −10° C. to −70° C., and even more preferably from −20° C. to −30° C. In another aspect, the cleaning article preferably includes a work surface (i.e., a surface for frictionally engaging another surface (e.g., a soiled surface to be cleaned)) comprising the binder, wherein the work surface has a wet kinetic coefficient of friction in the range from 0.3 to 0.9, preferably from 0.6 to 0.9.

In another aspect, the present invention provides a cleaning article comprising a nonwoven, three-dimensional fibrous web, a binder having a T_{g} not greater than 0° C., and a plurality of organic particles having a hardness of at least one of a Shore A hardness in the range from 80 to 100 or a Shore D hardness in the range from 30 to 50. The web is comprised of at least one (typically a plurality of) intertangled organic fiber(s). The binder is on at least a portion of a first major surface and binds the organic particles, at least in part, to the first major surface. Preferably, the binder is present on at least a majority of the first major surface. Typically, the binder is substantially co-extensive with the first major surface. Typically, the binder has a T_{g} in the range from 0° C. to −70° C., preferably from −10° C. to −70° C., and even more preferably from −20° C. to −30° C. In another aspect, the cleaning article preferably includes a work surface comprising the binder, wherein the work surface has a wet kinetic coefficient of friction in the range from 0.3 to 0.9, preferably from 0.6 to 0.9.

In another aspect, the present invention provides a cleaning article comprising a foam pad, binder having a T_{g} not greater than +10° C., and a plurality of organic particles having a Shore A hardness less than 80 (typically in the range from 10 to less than 80 or even 20 to less than 80). The binder is on at least a portion of a first major surface of the foam pad and binds the organic particles, at least in part, to the first major surface. Preferably, the binder is present on at least a majority of the first major surface. Typically, the binder is substantially co-extensive with the first major surface. The binder preferably has a T_{g} in the range from +10° C. to −70° C., preferably from −10° C. to −70° C., and even more preferably from −20° C. to −30° C. In another aspect, the cleaning article preferably includes a work surface comprising the binder, wherein the work surface has a wet kinetic coefficient of friction in the range from 0.3 to 0.9, preferably from 0.6 to 0.9.

In another aspect, the present invention provides a cleaning article comprising a foam pad, binder having a T_{g} not greater than 0° C., and a plurality of organic particles having a hardness of at least one of a Shore A hardness in the range from 80 to 100 or a Shore D hardness in the range from 30 to 50. The binder is on at least a portion of a first major surface of the foam pad and binds the organic particles, at least in part, to the first major surface. Preferably, the binder is present on at least a majority of the first major surface. Typically, the binder is substantially co-extensive with the first major surface. The binder preferably has a T_{g} in the range from 0° C. to −70° C., preferably from −10° C. to −70° C., and more preferably from −20° C. to −30° C. In another aspect, the cleaning article preferably includes a work surface comprising the binder, wherein the work surface has a wet kinetic coefficient of friction in the range from 0.3 to 0.9, preferably from 0.6 to 0.9.

Optionally, cleaning articles according to the present invention further comprise topical cleaners such as detergent solution cleaners, solvent emulsion cleaners, and combinations thereof.

In another aspect, the present invention provides a method of cleaning a soiled exterior aircraft surface using a cleaning article according to the present invention. The method comprises providing a cleaning article according to the present invention, frictionally engaging at least a portion of a work surface of the cleaning article with the soiled surface of the aircraft, and inducing relative motion between the cleaning article and the soiled exterior surface to at least partially dislodge soil from the soiled exterior surface. Optionally, the method further comprises providing a cleaner on the soiled exterior surface to aid in dislodging soil from the soiled exterior surface.

In another aspect, the present invention provides a method of cleaning a soiled exterior aircraft surface comprising providing a cleaning article comprising a non-woven, three-dimensional fibrous web at least 8 mm thick comprised of at least one entangled organic fiber, the web having a first major surface and binder on at least a portion of the major surface, the binder having a T_{g} not greater than 0° C., and the cleaning article includes a work surface comprising the binder, wherein the work surface has a wet kinetic coefficient of friction in the range from 0.3 to 0.9 (preferably from 0.6 to 0.9), frictionally engaging at least a portion of the work surface of the cleaning article with the soiled exterior surface of the aircraft, and inducing relative motion between the cleaning article and the soiled exterior surface to at least partially dislodge soil from the soiled exterior surface. The web is comprised of at least one (typically a plurality of) intertangled organic fiber(s). Preferably, the binder is present on at least a majority of the first major surface. Typically, the binder is substantially co-extensive with the first major surface. Optionally, the cleaning article further comprises a plurality of organic particles (e.g., at least one of a plurality of organic paricles having a Shore A hardness in the range from 80 to 100 or a Shore D hardness in the range from 30 to 50, or a plurality of organic particles having a Shore A hardness in the range from 20 to 80). Optionally, the method further comprises providing a cleaner on the soiled exterior surface to aid in dislodging soil from the soiled exterior surface.

In another aspect, the present invention provides a method of cleaning a soiled exterior aircraft surface comprising providing a cleaning article comprising a foam pad having a first major surface and binder on at least a portion of the first major surface, the binder having a T_{g} not greater than 0° C., and the cleaning article includes a work surface comprising the binder, wherein the work surface has a wet kinetic coefficient of friction in the range from 0.3 to 0.9 (preferably from 0.6 to 0.9), frictionally engaging at least a portion of the work surface of the cleaning article with the soiled exterior surface of the aircraft, and inducing relative motion between the cleaning article and the soiled exterior surface to at least partially dislodge soil from the soiled exterior surface. Preferably, the binder is present on at least a majority of the first major surface. Typically, the binder is substantially co-extensive with the first major surface. Optionally, the cleaning article further comprises a plurality of organic particles (e.g., at least one of a plurality of particles having a Shore A hardness in the range from 80 to 100 or a Shore D hardness in the range from 30 to 50, or a plurality of organic particles having a Shore A hardness in the range from 20 to 80). Optionally, the method further comprises providing a cleaner on the soiled exterior surface to aid in dislodging soil from the soiled exterior surface.

Cleaning articles according to the present invention can be used, for example, to clean soiled painted aircraft surfaces (e.g., low-gloss paint coatings, such as found on military aircraft, and high-gloss paint coatings, such as found on commercial aircraft). Certain preferred embodiments of the present invention can be used, for example, to clean surface and embedded soil on low gloss paint coatings without significantly increasing the gloss, and on high gloss paint coatings without significantly scratching or reducing the gloss.

### BRIEF DESCRIPTION OF THE DRAWINGS

FIG. 1 is a schematic side view in elevation of an exemplary cleaning article according to the present invention comprising a nonwoven web, a binder, and organic particles.

FIG. 1A is a schematic side view in elevation of another exemplary cleaning article according to the present invention comprising a nonwoven web, a binder, and organic particles.

FIG. 2 is a schematic side view in elevation of an exemplary cleaning article according to the present invention comprising a foam pad, a binder, and organic particles.

### DETAILED DESCRIPTION

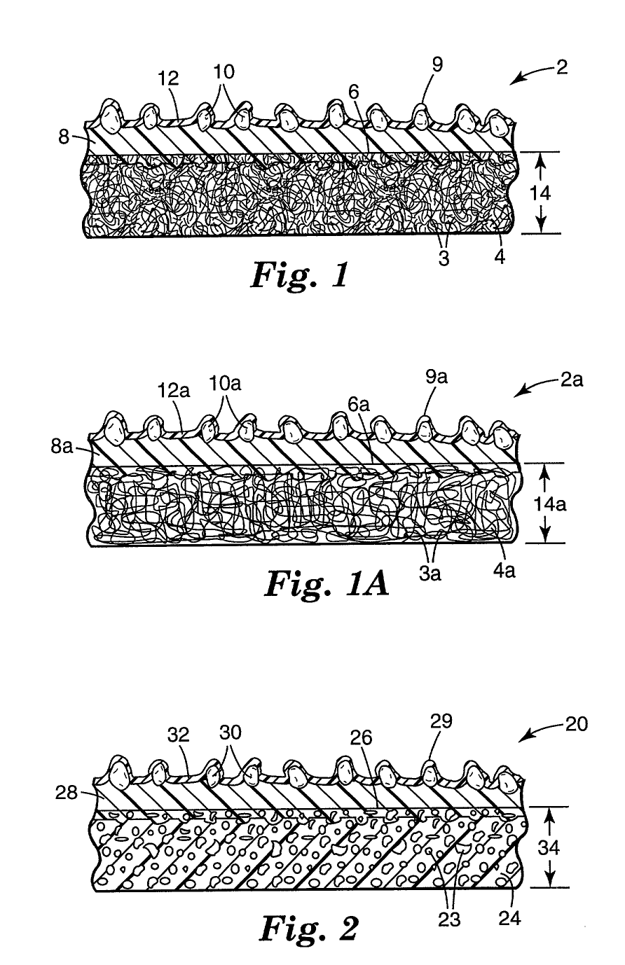

Referring to FIG. 1 cleaning article according to the present invention 2 comprises nonwoven, three dimensional fibrous web 4 and a plurality of organic particles 10 bonded to web 4 by binder 8. Fibrous web 4 has a thickness 14. For some cleaning methods according to the present invention, organic particles 10 are optional. Nonwoven web 4, as shown, comprises intertangled organic staple fibers 3, and has major surface 6. Further, as shown, binder 8 penetrates below major surface 6 into nonwoven web 4 and binds a portion of staple fibers 3 together. However, in some embodiments, there is little or no penetration of binder 8 below major surface 6. Also, as shown, optional size coat 12 coats binder 8 and organic particles 10 to aid in binding organic particles 10 to nonwoven web 4. Cleaning article 2 includes work surface 9.

Referring to FIG. 1A cleaning article according to the present invention 2 comprises nonwoven, three dimensional fibrous web 4A and a plurality of organic particles 10A bonded to web 4A by binder 8A. Fibrous web 4A has a thickness 14A. For some cleaning methods according to the present invention, organic particles 10A are optional. Nonwoven web 4A, as shown, comprises intertangled organic continuous fibers 3A, and has major surface 6A. Further, as shown, binder 8 penetrates below major surface 6A into nonwoven web 4A and binds a portion of fibers 3A together. However, in some embodiments, there is little or no penetration of binder 8A below major surface 6A. Also, as shown, optional size coat 12A coats binder 8A and organic particles 10A to aid in binding organic particles 10A to nonwoven web 4A. Cleaning article 2A includes work surface 9A.

Referring to FIG. 2 cleaning article according to the present invention 20 comprises foam pad 24 and plurality of organic particles 30 bonded to foam pad 24 by binder 28. Foam pad 24 has a thickness 34. For some cleaning methods according to the present invention, organic particles 10A are optional. Foam pad 24 has air spaces 23, and major surface 26. Further, as shown, binder 28 penetrates below major surface 26 into foam pad 24. However, in some embodiments, there is little or no penetration of binder 28 below major surface 26. Also, as shown, optional size coat 32 coats binder 28 and organic particles 30 to aid in binding organic particles 30 to foam pad 24. Cleaning article 20 includes work surface 29.

Suitable nonwoven webs for making cleaning articles according to the present invention, as well as nonwoven webs utilized in cleaning methods according to the present invention, include those comprised of continuous fiber(s), staple fibers, and combinations thereof. Such nonwoven webs, as well as techniques for making the nonwoven webs (e.g., airlaid processes, spunbond processes, carding processes, garneting processes, wetlay processes, and combinations thereof) are well known in the art. Optionally, the web may be further processed using techniques known in the art, such as cross-lapping, calendering, spunlacing, hydroentanglement, and/or needle-tacking.

Examples of staple fibers (i.e., fibers that are crimped and cut to a relatively short length) include natural fibers (e.g. cotton, wool, flax, etc.), synthetic fibers (e.g. polyamide, polyester, polyolefin, etc.), man-made fibers (e.g. viscose rayon), and combinations thereof (e.g., thermoplastic staple fibers (e.g., polyamides) and cellulosic staple fibers (e.g., viscose rayon) may be combined, where the weight percent of cellulosic fibers is typically in the range from 5 to 50 percent). Preferred staple fibers include polyamide fibers (e.g. nylon), polyester fibers, and polyolefin fibers. Typically, the staple fibers have a length less than about 15 cm, preferably less than about 10 cm, and most preferably less than about 7.5 cm, although fibers greater than 15 cm in length are also useful. In another aspect, the fibers typically have a diameter in the range from about 3 denier (3.3 dtex) per filament to about 200 (223 dtex) denier per filament. Such fiber diameters tend to produce webs having preferred structural integrity and surface area available for contact with the surface to be cleaned.

Examples of continuous fibers include synthetic fibers such as polyamide fibers (e.g., nylon), polyester fibers, and polyolefin fibers, and combinations thereof. Typically, the fibers have a diameter in the range from about 3 denier (3.3 dtex) per filament to about 1000 denier (1112 dtex) per filament. Such fiber diameters tend to produce webs having preferred structural integrity and surface area available for contact with the surface to be cleaned.

Optionally, the nonwoven webs may contain melt-bondable fibers and or other binder to bond fibers together. Examples of melt-bondable fibers include sheath-and-core and collateral bicomponent fibers having an exposed heat activatable adhesive surface. Suitable binders, which may also serve as a “prebond” coating, are known in the art, and include those comprising polyacrylates, poly(ethylene acrylic acid), sytrene-butadiene polymers, combinations thereof, and those described in U.S. Pat. No. 5,082,720 (Hayes), the disclosure of which is incorporated herein by reference.

Suitable foam pads for making cleaning articles according to the present invention, as well as nonwoven webs utilized in cleaning methods according to the present invention, include open-cell (i.e., those having generally intercommunicated voids) foams and closed-cell (i.e., those having voids that are generally discrete) foams. Such foams are known in the art, and include those available, for example, from Illbruck, Minneapolis, Minn.

Preferred material for making foam pad includes polyester urethane and polyether urethane. Preferably, the foam has a density in the range from about 0.5 lb./ft³ (0.008 g/cm³) to about 20 lb./ft³ (0.32 g/cm³).

Binder is present on at least a portion of at least one major surface of the web or pad. Typically, the binder preferably has, in increasing order of preference, T_{g} in the range from +10° C. to −70° C., +5° C. to −70° C. +0° C. to −70° C., −5° C. to −70° C., −10° C. to −70° C., −20° C. to −70° C., +10° C. to −50° C., +5° C. to −50° C., 0° C. to −50° C., −5° C. to −50° C., −10° C. to −50° C., and −20° C. to −50° C. Most preferably, the binder has a T_{g} in the range from −20° C. to −30° C. Binder with a T_{g} greater than about 0° C. typically does not provide sufficient friction to efficiently remove soil from the surface to be cleaned. Binder with a T_{g} less than −70° C. typically exhibits too much friction when in contact with the surface to be cleaned, thereby making the cleaning process more difficult. Suitable binders should be apparent to those skilled in the art, and include styrene-butadiene copolymer latex (available, for example, from Mallard Creek Polymers Division, Ameripol Synpol, Charlotte, N.C., under the trade designation “ROVENE 4306”). Other suitable binders include nitrile rubber emulsion (available, for example, from BFGoodrich Industrial Specialties, Cleveland, Ohio, under the trade designation “HYCAR 1572×64” (having a T_{g} of −30° C.)). The viscosity of the binder can be adjusted using techniques known in the art (e.g., diluting with solvent) to provide the desired coating viscosity.

Certain embodiments according to the present invention include organic particles bonded to at least a portion of at least one major surface of the web or pad. For certain preferred embodiments according to the present invention, the organic particles have a hardness of at least one of a Shore A hardness in the range from 80 to 100 or a Shore D hardness in the range from 30 to 50. Further, for certain preferred embodiments according to the present invention, the organic particles have a Shore A hardness less than 100, more preferably, less than 80, or even a Shore A hardness in the range from 10 to less than 100, 10 to less than 80, 20 to less than 100, or 20 to less than 80. Particle hardness can be measured by the penetration of an indentor foot into a sample specimen as described in ASTM Test Method D-2240-00, the disclosure of which is incorporated herein by reference. This ASTM test provides a measure of the relative resistance to indentation and is commonly expressed as “shore” hardness. For softer materials (typically rubbers), the hardness is expressed as a “Shore A” hardness, and for harder materials (typically rubbers), the hardness is expressed as a “Shore D” hardness. These two “shore” scales partially overlap, so that a hardness reading 80 to 100 on the “A” scale is equivalent to a hardness reading 30 to 50 on the “D” scale. Depending on the particular embodiment of the present invention, the organic particles typically have a Shore A hardness less than 100 (equivalent to a Shore D of less than 50), less than 80, or even a Shore A hardness in the range from 10 to less than 100, 10 to less than 80, 20 to less than 100, or 20 to less than 80. Suitable organic particles include those comprised of nitrile rubber (available, for example, from Zeon Chemicals, Louisville, Ky. under the trade designation “NIPOL 1411C”, having a Shore A hardness of about 30), thermoplastic polyester elastomer (available, for example, from DuPont Co., Willmington, Del., under the trade designation “HYTREL 4056”, having a Shore D hardness of 40), natural rubber, styrene-butadiene copolymer rubber, and polyurethane. Suitable organic particles can be made, for example, by subjecting organic precursor materials to grinding, milling, or other size reduction or granulation processes. To aid in grinding, milling, etc. of the organic materials, it may be desirable to freeze the material and grind, mill, etc. the material in a frozen state. Alternatively, for example, thermoplastic material can be made into suitable organic particles using molding or extrusion processes (e.g. pelletizing). Typically, the organic particles are roughly spherical or cylindrical in shape and have a diameter or length (i.e. a dimension of a major axis) in the range from about 0.05 mm to about 4 mm, preferably, in the range from about 0.05 mm to about 2 mm. Preferably, the organic particles have an aspect ratio (i.e., ratio of the dimension of the major axis to the dimension of the minor axis, wherein the minor axis is perpendicular to the major axis) in the range from about 1:1 to about 2:1.

It has been found that the optimal selection of a binder (and its associated T_{g}) for use in cleaning articles according to the present invention, or webs utilized in cleaning methods according to the present invention, can be dependent on the hardness of the organic particles selected. For example, harder organic particles (i.e., Shore A 100 or Shore D 50) require a binder having a lower T_{g} in order to avoid significant gloss changes or scratches in the surface to be cleaned. This consideration is particularly helpful to consider when using the relatively harder organic particles (i.e., particles having a Shore D hardness greater than about 30).

The binder utilized in the present invention may contain optional functional additives or fillers such as colorants, reinforcements, plasticizers, grinding aids, and/or conventional lubricants of the type presently used in surface treatment articles to adjust performance or appearance.

Examples of conventional lubricants include metal stearate salts such as lithium stearate and zinc stearate, and materials such as molybdenum disulfide. Examples of colorants are inorganic pigments, and organic dyes. Reinforcements may include, for example, short organic or inorganic fibers, spheres, and particles. Grinding aids include materials such as poly(vinyl chloride) and potassium fluoroborate. Fillers may include relatively soft organic particles or other materials which are primarily inert with respect to the utility of the articles. Plasticizers may include phthalic acid esters, oils, and other relatively low molecular weight (e.g., less than about 5000 Mₙ) materials.

The binder can be applied to a major surface of the web or pad using any of a variety of techniques including conventional techniques such as via roll coating, spray coating, curtain coating, extrusion coating, dip coating, brush coating, and combinations thereof. Alternatively, or in addition, binder can be incorporated into the web or foam during its manufacture. The binder, for example, may be present on a portion of the major surface, be on at least a majority of the major surface, be coextensive with the major surface, or be present throughout the web or foam. Further, for example, the binder may be present on selected portions (e.g., stripes or other patterns) of the major surface, and optionally may be present throughout the web or foam. The binder can be dried, cured, cooled, or otherwise solidified using conventional techniques. For cleaning articles including organic particles, the particles can be applied, for example to “wet” binder using conventional techniques such as particle dropping (i.e., the particles are applied via gravity or an air assist via a linear dispenser (e.g., a conveyor or air knife)), particle spraying, and combinations thereof. Alternatively, or in addition, for example, a slurry comprising the binder and organic particles may be used to simultaneously provide binder and organic particles.

The wet kinetic coefficient of friction of the work surface that contacts the surface to be cleaned typically provides sufficient interfacial friction to effectively dislodge unwanted soil from the surface while not providing so much friction so as to make movement of the cleaning article against the surface too difficult. Examples of preferred binders for this purpose include nitrile rubber, sytrene-butadiene rubber, and polyisoprene. Polyurethane tends to have less than preferred wet kinetic coefficients of friction.

Cleaning articles according to the present invention, as well as cleaning articles utilized in cleaning methods according to the present invention, may take any of a variety of conventional forms including sheets, blocks, strips, belts, brushes, rotary flaps, discs, or solid or foamed wheels. Wheels in the form of a disc or right circular cylinder having dimensions which may be relatively small (e.g., a cylinder height on the order of a few millimeters) or relatively large (e.g., two meters or more), and a diameter which may be relatively small (e.g., on the order of a few centimeters) or relatively large (e.g., one meter or more). The wheels typically have a central opening for support by an appropriate arbor or other mechanical holding device to enable the wheel to be rotated in use. Wheel dimensions, configurations, support devices, and rotation devices are well known in the art (see, for example, the 3M Company, St. Paul, Minn., publication entitled “3M Wheels”, published in 1990, the disclosure of which is incorporated herein by reference.

Cleaning articles according to the present invention, as well as cleaning articles utilized in cleaning methods according to the present invention, may be in the form of a layered composite. Layered composites (known in the art as “slabs”) may be produced, for example, by cutting, punching, or otherwise machining unhardened or partially hardened webs or foams into sheets or discs which are then overlapped on one another and then compressed and cured to make a higher density slab. Such cutting, punching and other machining techniques are well known to those skilled in the art. Layers of the composite may have the same or different dimensions.

Cleaning articles according to the present invention are particularly useful for cleaning (e.g., dislodging embedded or surface soil) soiled exterior surfaces of aircraft (e.g., commercial and military aircraft). Surface and embedded soil includes, for example, dirt, grim, grease, etc. Cleaning articles according to the present invention can be usefully employed, for example, by frictionally engaging (e.g., contacting) a cleaning article with the exterior surface of an aircraft and inducing relative motion between the article and the surface. Optionally, topical cleaners (which are typically liquids) may be used in conjunction with the cleaning method. Such topical cleaners include alkaline nonionic detergent cleaners, such as that available from the 3M Company under the trade designation “3M HEAVY DUTY AIRCRAFT CLEANER CONCENTRATE”, and solvent emulsion cleaners, such as that available from Zip-Chem Products Division of Andpak-EMA, Inc., San Jose, Calif. under the trade designation “CALLASOLV 120.”

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Example 1

Example 1 exemplifies a cleaning article according to the present invention having a nonwoven web with nitrile rubber particles bonded thereto.

An airlaid nonwoven web comprising a fiber blend of 70% (by weight of total fiber) of 15 denier per filament (16.7 dtex), 2 inch (51 mm) long, poly(ethylene terephthalate) staple fibers and 30% 25 denier per filament (27.8 dtex), 1.5 inch (38 mm) long, melt bondable sheath-and-core fibers (prepared according to Example 1 of U.S. Pat. No. 5,082,720 (Hayes), the disclosure of which is incorporated herein by reference, with the exception of the fiber size) was prepared as follows. The loose fibers were processed through an air lay machine (obtained from Curlator Corporation, East Rochester, N.Y., under the trade designation “RANDO WEBBER”). The resulting unbonded web was thermally bonded (i.e., the thermally-bondable fibers were activated by heat) via two passes (one each side) of the web through a 15-foot long (4.6 m) forced convection oven set at 350° F. (177° C.). The rate of traverse of the web through the oven was about 7.5 ft/min. (2.3 m/min), which resulted in a total dwell time of about 4 minutes. The resulting thermally-bonded, nonwoven web weighed 63 grains/24 in² (263 g/m²).

A binder, styrene-butadiene copolymer latex (obtained from Mallard Creek Polymers, Division of Ameripol Synpol, (Charlotte, N.C.) under the trade designation “ROVENE 4306”), was then roll coated to provide a 43 grains/24 in² (180 g/m²) (dry add-on weight) coating. The viscosity of the styrene-butadiene copolymer latex was measured at 72° F. (22° C.) using a digital viscometer (obtained from Brookfield Engineering Labs, Middleboro, Mass.) under the trade designation “LVTD”). The viscosity was adjusted by adding a 3% solids (aqueous) solution of hydroxypropyl methylcellulose (obtained from Dow Chemical Company, Midland, Mich., under the trade designation “METHOCEL F4M”) until the viscosity was 850 Centipoise (0.85 kg/(m·sec)). While the coated web was still wet, 69 grains/24 in² (288 g/m²) of 0.1 mm diameter nitrile rubber particles having a Shore A hardness of about 30 (obtained from Zeon Chemicals, Louisville, Ky., under the trade designation “NIPOL 1411C”) were applied via a particle coater (obtained from ITWGema, Indianapolis, Ind., under the trade designation “GEMA TYPE PGC 1”). In general, the nitrile rubber particles were applied to the web as described in U.S. Pat. No. 6,017,831 (Beardsley et al.), the disclosure of which is incorporated herein by reference.

The nitrile rubber particles were fluidized and transported by the particle coater to the distribution nozzle by way of a venturi tube into the particle sprayer. The particle sprayer exit was adjusted to a sufficient height above the surface of the web to deposit the particles across the entire surface of the web. The web was passed underneath the sprayer at a web speed of approximately 2.3 meters/minute (7.5 feet/minute). The resulting composite was dried in a 15-foot long (4.6 m) forced convection oven set at 350° F. (177° C.), with a residence time of about 4 minutes. The cured binder coating had a T_{g} of −25° C.

The resulting dried web was then spray coated with an additional 27 grains/24 in² (113 g/m²) (dry add-on weight) coating of styrene-butadiene copolymer latex (“ROVENE 4306”) having a viscosity adjusted to 120 Centipoise (0.12 kg/(m·sec)) with the hydroxypropyl methylcellulose solution. The resulting composite was then again heated in a forced convection oven for 4 minutes at 350° F. (177° C.). The resulting web was about 1 inch (2.5 cm) thick, and weighed 202 grains/24 in² (844 g/m²).

The density of the web was determined by die cutting a 4 inch (10.16 cm) diameter specimen. The die cut specimen was weighed, and its thickness measured using a digital measuring device (obtained from Mitutoyo, Ltd., Andover, Hampshire, UK, under the trade designation “MITUTOYO DIGITAL INDICATOR”). From these measurements, the density of the web was determined to be 0.04 g/cm³.

### Example 2

Example 2 exemplifies a cleaning article according to the present invention comprising a foam pad and binder. A 1.25 inch (3.2 cm) thick polyether polyurethane foam (obtained from Illbruck, Minneapolis, Minn., under the trade designation “P80 RMI 11321”) was die cut to provide a 4 inch×6 inch (10.2 cm×15.2 cm) piece of the foam. The weight of the die cut piece was 11.8 grams. About 80 ml of a pre-vulcanized natural rubber latex (55% solids; obtained from Killian Latex, Inc., Akron, Ohio, under the trade designation “K-300 #2 PRECURE”) was poured into the bottom of a 28 cm×18 cm glass pan. The foam piece was pressed into the latex on the bottom of the glass pan and allowed to blot up the latex. The latex-coated foam piece was dried for 1 hour in an oven set for 295° F. (146° C.). The dry coating weight of the latex was 16.9 grams/24 in² (1090 g/m³). The T_{g} of the cured binder was −70° C.

### Example 3

Example 3 exemplifies a cleaning article according to the present invention having a needletacked nonwoven web and binder. An air laid nonwoven web comprised of 15 denier per filament (16.7 dtex), 2 inch (51 mm) long poly(ethylene terephthalate) stable fibers was prepared as follows. The loose fibers were processed through an air lay machine (“RANDO WEBBER”). The resulting unbonded web was run through a needletacker (obtained from James Hunter Machine Corp., North Adams, Mass.) with the needle board set with 15×18×25×3.5RB needles (obtained from Foster Needle Company, Manitowoc, Wis.). Penetration depth of the needles was set at 9 mm. The stroke cycles were set at 11 cycles per 10 inch length (49.5 strokes/in² (7.7 strokes/cm³). The needletacked web had a weight of 53 grains/24 in² (221 gm/m²).

The needletacked web was roll coated with the styrene-butadiene copolymer latex described in Example 1, to provide a coating (dry add-on weight) of 36 grains/24 in² (150 gm/m²). The resulting web was dried as described in Example 1. The resulting cleaning article weighed 89 grains/24 in² (371 g/m²), and was about 8 mm thick.

### Example 4

Example 4 exemplifies a cleaning article according to the present invention having a nonwoven web, binder, and organic particles. A needle tacked web was prepared as described in Example 3. The web was sprayed on one side with a styrene-butadiene copolymer latex slurry utilizing a spray gun (obtained from Midway Industrial Supply Co., St. Paul, Minn., under the trade designation “BINKS SPRAY GUN #601” equipped with nozzle #68 and cap # 67PB). The spray was delivered to the spray gun utilizing a pressure tank (obtained from Midway Industrial Supply Co., St. Paul, Minn., under the trade designation “BINKS PRESSURE TANK”, Model # 83-5508). The stream of spray was delivered through the nozzle with turbulant air flow to atomize the stream. The spray gun was reciprocated across the web at 45 reciprocations per minute to provide a wet add-on weight of 153 grains/24 in² (639.5 g/m²). The slurry was prepared by mixing together 12.2 lbs (5.54 kg) of styrene-butadiene copolymer latex (“ROVENE 4306”), 0.25 lb. (0.11 kg) of a 3% aqueous solution of hydroxypropyl methylcellulose (“METHOCEL F4M”), and 1 lb. (0.454 kg) of nitrile rubber particles (“NIPOL 1411C”). The resulting spray-coated web was dried in a 15-foot long (4.6 m) forced convection oven set at 350° F. (177° C.), with a residence time of about 4 minutes. The T_{g} of the cured binder was −25° C. The resulting cleaning article weighed 170 grains/24 in² (710.6 g/m²), and was about 9 mm thick.

### Example 5

Example 5 exemplifies a cleaning article according to the present invention having a nonwoven web, binder, and organic particles. A roll-coated, melt-bonded web was made as described in Example 1. The resulting web included63 grains/24 in² (263 g/m²) of the thermally-bonded web and 43 grains/24 in² (180 g/m²) of the dried latex polymer.

Thermoplastic elastomer pellets (obtained from DuPont, Elastomer Chemicals Department, Wilmington, Del., under the trade designation “HYTREL 4056”) were placed under liquid nitrogen for 15 minutes, and while frozen reduced in size with a lab grinder (obtained from C. W. Brabender Instruments, Inc., South Hackensack, N.J.). The ground particles were screened using a U.S. Standard No.10 sieve (obtained from W. S. Tyler Company, Mentor, Ohio) to retain the +10 mesh sized particles. 80 ml of a styrene-butadiene copolymer latex (obtained from Mallard Creek Polymers, Division of Ameripol Synpol, under the trade designation “ROVENE 4150”; T_{g} of −14° C.) was placed into the bottom of a 28×18 cm glass pan. A 3″×3″ (7.62 cm×7.62 cm) web specimen was placed in to the pan and allowed to blot up the latex. The amount of latex applied was sufficient to result in a dry add-on weight of about 5.0 g/9 in²(856 g/m²). A sufficient amount of the +10 mesh thermoplastic elastomer particles (“HYTREL 4056”) were placed in to the wet latex to provide a dry add-on weight of about 2.9 g/9 in²(496 g/m²). The resulting sample was dried in an oven for 15 minutes at 200° F. (93° C.), followed by 15 minutes at 220° F. (104° C.).

The particle-coated web was placed into a glass pan with 80 ml of a styrene-butadiene copolymer latex (“ROVENE 4150”) to further bond the thermoplastic elastomer particles (“HYTREL 4056”) to the web surface. The styrene-butadiene copolymer latex (“ROVENE 4150”) was then dried for 15 minutes at 200° F. (93° C.), followed by 15 minutes at 240° F. (116° C.) to provide a dry add-on weight of about 0.4 G/9 in²(68 g/m²). The total dry weight of the finished cleaning article was 11.1 g/9 in²(1900 g/m²).

### Example 6

Example 6 exemplifies a cleaning article according to the present invention comprising a nonwoven web, binder, and organic particles. A nonwoven web comprising 15 denier (17 dtex) polyester staple fibers (commercially available under the trade designation “SUPER POLISH INDUSTRIAL SHEET”, from the 3M Company) was coated with a styrene-butadiene copolymer latex (obtained from Mallard Creek Polymers, Division of Ameripol Synpol, under the trade designation “ROVENE 5900”; T_{g} of 4° C.). A 4×6 inch (10.16 cm×15.24 cm) web specimen was placed into a 28×18 cm glass pan in which 80 ml of the latex (“ROVENE 5900”) had been poured. The wet coated specimen was removed and about 11 g of polyurethane polymer pellets with Shore A hardness of 75 (obtained from BFGoodrich Company, Specialty Chemicals, Cleveland, Ohio., under the trade designation “ESTANE 58213”) were placed on the wet latex surface. The latex was dried at 240° F. (115° C.) for about 60 minutes. The dry add-on weight of the latex was about 30 grains/24 in²(126 g/m²).

### Example 7

Example 7 exemplifies a cleaning article according to the present invention comprising a foam pad, binder, and organic particles. A 1.25 inch (3.2 cm) thick polyether polyurethane foam (“P80 RMI 11321”) was die cut to provide a 4 inch×6 inch (10.2 cm×15.2 cm) piece. The weight of the die cut piece was 11.8 grams. A latex mixture containing 86.2% styrene-butadiene copolymer latex (“ROVENE 4306”), 12.1% nitrile rubber particles (“NIPOL 1411C”), and 1.7% of a 3% solids (aqueous) solution of hydroxypropyl methylcellulose (“METHOCEL F4M”) solution was prepared. About 80 ml of this latex mixture was poured into the bottom of a 28 cm×18 cm glass pan. The foam pad was pressed into this mixture, and allowed to blot up the latex mixture. The latex mixture coated pad was dried for 1 hour in an oven set at 250° F. (121° C.). The dry add-on weight of the latex mixture was 16.8 grams/24 in²(1084 g/m²).

### Comparative Example A

Comparative Example A exemplifies a cleaning article having a nonwoven web with particles having a Shore D hardness of 55 and a binder with a T_{g} of −25° C. An airlaid, melt-bonded, nonwoven web was prepared as described in Example 1. A 4 in×6 in (155 cm²) piece was die cut from the web, and weighed 63 grains/4 in×6 in (263 g/m²). About 80 ml of styrene-butadiene copolymer latex binder (“ROVENE 4306”) was poured onto the bottom of a 28 cm×18 cm glass pan. The web specimen was pressed into the latex on the bottom of the glass pan, and allowed to blot up the latex to provide a dry add-on weight of 173 grains/24 in² (722 g/m²). Ten grams of thermoplastic polyester elastomer organic particles having a Shore D hardness of 55 and average particle size of 4 mm (obtained from DuPont Co, Willmington, Del., under the trade designation “HYTREL 5544”) were then coated onto the web. The particles were pre-wetted with a sufficient amount of the styrene-butadiene copolymer latex binder (“ROVENE 4306”) to provide an add-on weight of 46 grains/24 in² (192 g/m²). The resulting particles were coated onto the resin-coated surface of the sample with a tongue blade. The resulting sample was dried in a forced convection oven for 20 minutes at 225° F. (107° C.). A size coat was then applied to the particle-coated web to further bond the organic particles to the web. 80 ml of a styrene-butadiene copolymer latex (“ROVENE 4306”) was placed in the bottom of a glass pan, and the particle coated web pressed into the latex. The coated web was then dried in an oven for 30 minutes at 225° F. (107° C.), followed by an additional 5 minutes at 290° F. (143° C.) to provide a dry add-on weight of 79 grains/24 in² (330 g/m²). The weight of the resulting cleaning article was 515 grains/24 in² (2150 g/m²).

### Comparative Example B

Comparative Example B exemplifies a cleaning article having a nonwoven, a binder with a T_{g}>10° C., and particles having a hardness greater than Shore D 50. Comparative Example B was prepared as Example 5, except the binder was an acrylic latex resin (obtained from Rohm & Haas Co, Philadelphia, Pa, under the trade designation “HA-16”), and the organic particles were those obtained from DuPont Co. under the trade designation “HYTREL 5526”.

### Comparative Example C

Comparative Example C exemplifies a cleaning article having a nonwoven web, binder, and inorganic particles, that both scratches and changes the gloss of test panels. An airlaid, melt-bonded, nonwoven web was prepared as described in Example 1, except the thermally-bonded nonwoven fibrous web had a weight of 92 grains/24 in² (384 g/m²). The web was roll coated, as described in Example 1, with a slurry prepared by mixing together 3.18 kg of styrene-butadiene copolymer latex (“ROVENE 4306”) and 1.36 kg of calcium carbonate (obtained from J. M. Huber Corporation, Edison, N.J.). The slurry was dried described as in Example 1. The dry add-on weight of the slurry was 84 grains/24 in² (351 g/m²). The web was roll coated a second time with the slurry and dried. The additional dry add-on weight from the second slurry coat was 205 grains/24 in² (857 g/m²).

### Comparative Example D

Comparative Example D is a nonwoven cleaning article (commercially available under the trade designation “TYPE T SURFACE CONDITIONING SHEET” from the 3M Company) that is marketed for use in cleaning soiled exterior surfaces of aircraft. The cleaning article is comprised of a needletacked nonwoven web of organic staple fibers and a talc filled polyurethane binder.

### Comparative Example E

Comparative Example E is a nonwoven cleaning article (commercially available under the trade designation “SUPER POLISH INDUSTRIAL SHEET” from the 3M Company) that is marketed for use in cleaning soiled exterior surfaces of aircraft. The cleaning article is comprised of a nonwoven web of staple, organic fibers and a talc filled styrene-butadiene copolymer latex (“ROVENE 5900”) binder having a T_{g} of +4° C.

### Cleaning Evaluation of Examples 1-7 and Comparative Examples A-E

The cleaning effectiveness of Examples 1-7 and Comparative examples A-E were evaluated as follows. The cleaning test consisted of cleaning a soiled tile with a cleaning article. An oily dirt mixture was prepared by mixing 4.0 grams of dirt (available from the 3M Company, St. Paul, Minn., under the trade designation “3M STANDARD CARPET DRY SOIL”; order number SPS-2001) with 1.0 gram of motor oil (obtained from Valvoline Division of Ashland Incorporated, Lexington, Ky. under the trade designation “5W30”). Next, 2.5 grams of the oily dirt mixture were placed on a white vinyl composition floor tile (obtained from Armstrong World Industries, Inc., Lancaster, Pa., under the trade designation “EXCELON 56830”). Using latex rubber gloves, the oily dirt mixture was vigorously rubbed into the tile until the tile surface was uniformly soiled with the mixture. Excess mixture was wiped off the tile with a paper towel.

The cleaning articles to be tested were cut into 3.5 inch×2 inch (8.9 cm×5.1 cm) test samples. The test samples were immersed in tap water at approximately 35° C., removed, and excess water shaken off. The test sample was then contacted with a soiled tile using the index and middle finger, and vigorously rubbed (i.e., approximately 4-6 kg applied force) along a single path on the tile surface with a reciprocating motion. The test ended after 10 traverses. The path cleaned was approximately 4 inches long by 1.5 inch (10×4 cm) wide.

The cleaning performance of the test sample was then determined by visually ranking the rubbed portion of the soiled tile using the following system: a test surface that was entirely cleaned received a rating of 1; a test surface mostly cleaned received a rating of 2; a test surface minimally cleaned received a rating of 3; and a test surface not cleaned at all received a rating of 4. For each 12 in×12 inch tile, eight tests were performed using a 4×2 array of test blocks of equal area. Following performance rating, the test tiles were cleaned, dried, and reused. The results are summarized in Table 1.

TABLE 1

| | | | | | | | | Scratch | Wet |
|---|---|---|---|---|---|---|---|---|---|
| | | | | Particle | Particle | Cleaning | Gloss Test, | Test, | Kinetic |
| | | Binder | | hardness, | hardness, | Test | change in | scratch(s) | Coefficient |
| Example | Binder | T_{g}, ° C. | Particles | Shore A | Shore D | Ranking | gloss | present | of Friction |
| 1 | “ROVENE | −25 | “NIPOL” | 30 | — | 2 | No | No | 0.88 |
| | 4306” | | 1411C | | | | | | |
| 2 | Natural | −70 | — | N/A | N/A | 1 | No | No | 0.65 |
| | rubber | | | | | | | | |
| 3 | “ROVENE | −25 | — | N/A | N/A | 3 | No | No | 0.54 |
| | 4306” | | | | | | | | |
| 4 | “ROVENE | −25 | “NIPOL” | 30 | — | 2 | No | No | 0.76 |
| | 4306” | | 1411C | | | | | | |
| Comp. A | “ROVENE | −25 | HYTREL” | — | 55 | 3 | No | No | — |
| | 4306” | | 5544 | | | | | | |
| 5 | “ROVENE | −14 | “HYTREL” | — | 40 | 3 | No | No | 0.37 |
| | 4150” | | 4056 | | | | | | |
| 6 | ROVENE | 4 | “ESTANE” | 75 | — | 3 | No | No | — |
| | 5900” | | 58213 | | | | | | |
| 7 | “ROVENE | −25 | “NIPOL” | 30 | — | 2 | No | No | 0.84 |
| | 4306” | | 1411C | | | | | | |
| Comp. B | R&H HA-16 | 35 | “HYTREL | — | 55 | 4 | Yes | No | — |
| | | | 5526” | | | | | | |
| Comp. C | “ROVENE | −25 | Calcium | Mohs | 1 | Yes | Yes | — | |
| | 4306” | | carbonate | hardness = 3 | | | | | |

| | | | | | | | | |
|---|---|---|---|---|---|---|---|---|
| Comp. D | poly- | | talc | Mohs hardness = 1 | 4 | No | No | 0.25 |
| | urethane | | | | | | | |
| Comp. E | styrene- | +4 | talc | Mohs hardness = 1 | 4 | No | No | 0.26 |
| | butadiene | | | | | | | |
| | copolymer | | | | | | | |
| | latex | | | | | | | |

Gloss Test

The effect a cleaning article had on the gloss of a low-gloss (e.g., matte) painted surface was determined as follows. A degreased, cleaned, cold-rolled steel metal panel (12 in.×12 in.×30.5×30.5 cm); obtained from ACT Labs, Hillsdale, Mich., under the trade designation “APR-25168”) was spray-painted on its backside with a low-gloss gray primer paint (aerosol can obtained from Brite Touch, The Specialty Division, Division of the Sherwin-Williams Company, Solon, Ohio, under the trade designation “BT-49”). Four coats of the paint were applied to the metal panel per the instructions on the aerosol can. The cleaning articles to be tested were cut into 3.5 in×2 in (8.9 cm×5.1 cm) test samples. The test samples were immersed in tap water at approximately 35° C., removed, and excess water shaken off. The test sample was then contacted with the painted metal panel using the index and middle finger, and vigorously rubbed (i.e., approximately 4-6 kg applied force) along a single path on the painted metal surface with a reciprocating motion. The test ended after 10 traverses. The path rubbed was approximately 4 inches long by 2 inches wide (10×5 cm). Excess water was wiped from the panel surface, and the panel was allowed to dry at room temperature for approximately 15 minutes.

The change in gloss of the metal panel for a given test sample was then determined by visually observing scratches or changes in gloss relative to a control painted metal panel (i.e., one not having been rubbed). The results are summarized in Table 1, above.

Scratch Test

The effect a cleaning article had on the gloss of a high-gloss painted surface was determined as follows. The test panel utilized was a high gloss panel (18 in.×30 in. (45.7 cm×76.2 cm) obtained from ACT Labs, Hillsdale, Mich., under the trade designation “APR-25168”). The cleaning articles to be tested were cut into 3.5 in×2 in (8.9 cm×5.1 cm) test samples. The test samples were immersed in tap water at approximately 35° C., removed, and excess water shaken off. The test sample was then contacted with the high gloss panel using the index and middle finger, and vigorously rubbed (i.e., approximately 4-6 kg applied force) along a single path on the panel surface with a reciprocating motion. The test ended after 10 traverses. The path rubbed was approximately 4 inches long by 2 inches wide (10×5 cm). Excess water was wiped from the panel surface, and the panel was allowed to dry at room temperature for approximately 15 minutes.

The change in gloss of the metal panel, and presence of scratches, produced by a given test sample were determined by visually comparing scratches or changes in gloss versus a control (untested) panel.

Wet Kinetic Coefficient of Friction Test

The wet kinetic coefficient of friction of the work surfaces of the samples were determined using a friction/peel tester (obtained from Thwing-Albert, Philadelphia, Pa.; Model 225-1) and a 2000 gram load cell (obtained from Thwing-Albert; T-A model 771-343). Test samples were cut to 2.5 inches×2.5 inches (6.35 cm×6.35 cm) wide by 0.25 inches (0.64 cm) thick, immersed in tap water at approximately 35° C., removed, and the excess water shaken off. The test samples were secured to the bottom of a test “sled” (which was part of the friction/peel tester) by fastening the surface opposite the work surface to the sled. A hook structure (available from the 3M Company, St. Paul, Minn., under the trade designation “3M MECHANICAL FASTENER DIAPER CLOSURE SYSTEM”) was attached to the bottom side of the sled with double-sided tape. The hook structure was a film formed with the following characteristics: stem height equal to approximately 0.020 inches (0.05 cm), stem diameter equal to 0.016 inches (0.04 cm), head diameter equal to 0.030 inches (0.08 cm), stem spacing equal to 0.055 inches (0.14 cm), and stem density equal to 325 stems/inch (128 stems/cm). The surface opposite the work surface was attached to the hook structure. The test samples were frictionally tested against 18 in.×4.5 in. (45.7 cm×11.4 cm) high gloss test panels (obtained from ACT Labs, Hillsdale, Mich., under the trade designation “APR-25168”). A 10-second test was conducted at a speed of 6.1 inches/minute (15.5 cm/minute) utilizing a 500 gram sled. The average of 5 individual readings is reported in Table 1, above. Acceptable wet kinetic coefficients of friction are between 0.3 and 0.9, using this test.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A cleaning article comprising:
a non-woven, three dimensional fibrous web comprised of at least one intertangled organic fiber, the web having a first major surface;
a plurality of organic particles having a Shore A hardness less than 80; and
binder on at least a portion of the first major surface, the binder having a T_{g} not greater than +10° C. and binding the organic particles, at least in part, to the first major surface.

2. A cleaning article according to claim 1, wherein the web is comprised of a plurality of intertangled organic fibers.

3. A cleaning article according to claim 2, wherein the binder is present on at least a majority of the first major surface.

4. A cleaning article according to claim 2, wherein the binder is substantially co-extensive with the first major surface.

5. A cleaning article according to claim 2, wherein the binder binds at least a portion of the fibers together.

6. A cleaning article according to claim 2, wherein said organic particles have a Shore A hardness in the range form 20 to less than 80.

7. A cleaning article according to claim 2, wherein the web has a density in the range from 0.02 g/cm³ to 0.3 g/cm³.

8. A cleaning article according to claim 2, wherein the T_{g} is in the range from 0° C. to −70° C.

9. A cleaning article according to claim 2, wherein the T_{g} is in the range from −10° C. to −70° C.

10. A cleaning article according to claim 2, wherein the T_{g} is in the range from −20° C. to −30° C.

11. A cleaning article according to claim 1, wherein said organic particles have a Shore A hardness in the range from 20 to less than 80.

12. A cleaning article according to claim 1, wherein s aid organic particles have an aspect ratio in the range from about 1:1 to about 2:1.

13. A cleaning article comprising:
a non-woven, three dimensional fibrous web comprised of at least one intertangled organic fiber, the web having a first major surface;
a plurality of organic particles having a hardness of at least one of a Shore A hardness in the range from 80 to 100 or a Shore D hardness in the range from 30 to 50; and
binder on at least a portion of the first major surface, the binder having a T_{g} not greater than 0° C. and binding the organic particles, at least in part, to the first major surface.

14. A cleaning article according to claim 13, wherein the web is comprised of a plurality of intertangled organic fibers.

15. A cleaning article according to claim 14, wherein the binder is present on at least a majority of the first major surface.

16. A cleaning article according to claim 14, wherein the binder is substantially co-extensive with the first major surface.

17. A cleaning article according to claim 14, wherein the binder binds at least a portion of the fibers together.

18. A cleaning article according to claim 14, wherein the web has a density in the range from 0.02 g/cm³ to 0.3 g/cm³.

19. A cleaning article according to claim 14, wherein the T_{g} is in the range from 0° C. to −70° C.

20. A cleaning article according to claim 14, wherein the T_{g} is in the range from −10° C. to −70° C.

21. A cleaning article according to claim 14, wherein the T_{g} is in the range from −20° C. to −30° C.

22. A cleaning article according to claim 13, wherein said organic particles have an aspect ratio in the range from about 1:1 to about 2:1.

23. A cleaning article comprising:
a foam pad having a first major surface;
a plurality of organic particles having a Shore A hardness less than 80; and
binder on at least a portion of the first major surface, the binder having a T_{g} not greater than +10° C. and binding the organic particles, at least in part, to the first major surface.

24. A cleaning article according to claim 23, wherein the binder is present on at least a majority of the first major surface.

25. A cleaning article according to claim 23, wherein said organic particles have a Shore A hardness in the range form 20 to less than 80.

26. A cleaning article according to claim 23, wherein the binder is substantially co-extensive with the first major surface.

27. A cleaning article according to claim 23, wherein the T_{g} is in the range from 0° C. to −70° C.

28. A cleaning article according to claim 23, wherein the T_{g} is in the range from −10° C. to −70° C.

29. A cleaning article according to claim 23, wherein the T_{g} is in the range from −20° C. to −30° C.

30. A cleaning article according to claim 23, wherein said organic particles have an aspect ratio in the range from about 1:1 to about 2:1.

31. A cleaning article comprising:
a foam pad having a first major surface;
a plurality of organic particles having a hardness of at least one of a Shore A hardness in the range from 80 to 100 or a Shore D hardness in the range from 30 to 50; and
binder on at least a portion of the first major surface, the binder having a T_{g} not greater than 0° C. and binding the organic particles, at least in part, to the first major surface.

32. A cleaning article according to claim 31, wherein the binder is present on at least a majority of the first major surface.

33. A cleaning article according to claim 31, wherein the binder is substantially co-extensive with the first major surface.

34. A cleaning article according to claim 31, wherein the T_{g} is in the range from 0° C. to −70° C.

35. A cleaning article according to claim 31, wherein the T_{g} is in the range from −10 C. to −70° C.

36. A cleaning article according to claim 31, wherein the T_{g} is in the range from −20° C. to −30° C.

37. A cleaning article according to claim 31, wherein said organic particles have an aspect ratio in the range from about 1:1 to about 2:1.

38. A method of cleaning a soiled exterior surface of an aircraft, the method comprising:
providing a cleaning article comprising a non-woven, three-dimensional fibrous web, at least 8 mm thick, comprised of at least one intertangled organic fiber, the web having a first major surface and binder on at least a portion of the first major surface, the binder having a T_{g} not greater than 0° C., said cleaning article further comprising a work surface comprising said binder, and said work surface having a wet kinetic coefficient of friction in the range from 0.3 to 0.9;
frictionally engaging at least a portion of the work surface of the cleaning article with the soiled exterior surface of the aircraft; and
inducing relative motion between the cleaning article and the soiled exterior surface to at least partially dislodge soil from the soiled exterior surface.

39. A method according to claim 38, wherein the web is comprised of a plurality of intertangled organic fibers.

40. A method according to claim 39, wherein the cleaning article further comprises a plurality of organic particles having a Shore A hardness less than 100, and wherein the binder bonds the organic particles, at least in part, to the first major surface.

41. A method according to claim 39, wherein the cleaning article further comprises a plurality of organic particles having Shore A hardness less than 80, and wherein the binder bonds the organic particles, at least in part, to the first major surface.

42. A method according to claim 39, wherein the cleaning article further comprises a plurality of organic particles having a hardness of at least one of a Shore A hardness in the range from 80 to 100 or a Shore D hardness in the range from 30 to 50, and wherein the binder bonds the organic particles, at least in part, to the first major surface.

43. A method according to claim 39, wherein the cleaning article further comprises a plurality of organic particles having a Shore A hardness in the range from 20 to 80, and wherein the binder bonds the organic particles, at least in part, to the first major surface.

44. A method according to claim 39 further comprising providing a cleaner on the soiled exterior surface to aid in dislodging soil from the soil exterior surface.

45. A method of cleaning a soiled exterior surface of an aircraft, the method comprising:
providing a cleaning article comprising a foam pad, the foam pad having a first major surface and binder on at least a portion of the first major surface, the binder having a T_{g} not greater than 0° C., said cleaning article further comprising a work surface comprising said binder, and said work surface having a wet kinetic coefficient of friction in the range from 0.3 to 0.9;
frictionally engaging at least a portion of the work surface of the cleaning article with the soiled exterior surface of the aircraft; and
inducing relative motion between the cleaning article and the soiled exterior surface to at least partially dislodge soil from the soiled exterior surface.

46. A method according to claim 45, wherein the cleaning article further comprises a plurality of organic particles having a hardness of at least one of a Shore A hardness in the range from 80 to 100 or a Shore D hardness in the range from 30 to 50, and wherein the binder bonds the organic particles, at least in part, to the first major surface.

47. A method according to claim 45 further comprising providing a cleaner on the soiled exterior surface to aid in dislodging soil from the soil exterior surface.
